(19) United States
(12) Patent Application Publication
(10) Pub. No.: US 2007/0169507 A1
(43) Pub. Date: Jul. 26, 2007

(54) Cooling storage device

(76) Inventor: Guo-Ching Wu, Sanchong City (TW)

Correspondence Address: TROXELL LAW OFFICE PLLC, SUITE 1404, 5205 LEESBURG PIKE, FALLS CHURCH, VA, 22041, US

(21) Appl. No.: 11/338,676

(22) Filed: Jan. 25, 2006

(51) Int. Cl. F17C 13/00; F25D 11/00

(52) U.S. Cl. 62/457.9; 62/440

(57) ABSTRACT

This invention is about a kind of improvement of cooling storage device structure. This proposed cooling storage device structure has gyro wheels at the every corner on the bottom surface of the shell. Inside the shell, there is a separating panel to separate into the upper and the down deck. At the lower deck, there is a cooling system which is made up of the compressor, condenser, desiccator, and etc. The upper deck has the function of preservation and refrigeration of food items. And there are also condensing pipes surrounding inside the walls of the upper deck which are connected to the cooling system in the lower deck. Besides, an access door with a doorknob is setup at one side of upper deck for the convenience of putting in or taking out the food items inside. Moreover, outside the lower deck shell there is a power switch. Especially, a punch is created on the top of the shell that is connected to the upper deck. The punch offers a space to place a container in it, and there is a cover on the container to enclose it. Thus, the container could also have the function of preserving and refrigerating, and also provide the facilities of putting in or taking out the food items.

### BACKGROUND OF THE INVENTION

In nowadays, methods of dealing with refrigeration of food items are usually to use a large icebox or a small cooling storage device according to the situation you need. It seems there is no problem with it and can also satisfy most user's need. In practice we will find that, the volume of an icebox is usually too large although it can preserve and refrigerate much more food. However, in real situation some inconvenience will result from frequently opening the door when we want to take something out of it, especially the stuff is much far from the door. Although the volume of the cooling storage device is much smaller, it provides less space to preserve and refrigerate the food materials. And the inconvenience of frequently opening the door when we want to take something out of it as the aforesaid still exists. Moreover, when frequently opening the door will make the cold air inside the refrigerator flow out, resulting in a rising of temperature inside the refrigerator. Thus, the compressor of the refrigerator has to work harder to lower the temperature down, that means a waste of energy occurs. So, no matter what kind of iceboxes or cooling storage device will suffer from some inconveniences as we mention above.

### SUMMARY OF THE INVENTION

The main purpose of this creation lies in offering a kind of cooling storage device structure improvement. By creating a punch on the top surface of the shell in the suitable location, we can offer a container to inlay. And with a cover on the container, the container can also have the capabilities of preserving and refrigerating stuff just like the upper deck of the cooling storage device. When using it, we can directly open the cover of the container on the top of the shell to put in or take out the food item inside. This can not only save the energy efficiently but also provide the user another convenient way of using such a cooling storage device.

In order to reach above-mentioned purposes, this proposed cooling storage device structure has gyro wheels at the every comer on the bottom surface of the shell. Inside the shell, there is a separating panel to separate the said shell into an upper and a lower deck. At the lower deck, there is a cooling system which is made up of compressor, condenser, desiccator, and etc. The upper deck offers the preservation and refrigeration of food, and there are also condensing pipes that connected to the cooling system surrounding the inside walls of the upper deck. Besides, an access door with a doorknob is setup to one side of upper deck for the convenience of putting in or taking out the food items. Moreover, outside the lower deck shell there is a power switch. Especially, a punch is created on the top of the shell that is connected the upper deck. The punch offers a space to place a container in it, and there is also a cover on the container to enclose it. Thus, the container on the top of the cooling storage device could also have the function of preserving and refrigerating, and also provide the facilities of putting in or taking out the food item.

### BRIEF DESCRIPTION OF THE DRAWINGS

FIG. 1. Shows the appearance of the cooling storage device structure in this invention.

FIG. 2. Shows the decomposed diagram of the cooling storage device structure in this invention.

FIG. 3. Shows the front view and top view of cooling storage device structure in this invention.

| | |
|---|---|
| Cooling storage device (1) | Shell (10) |
| Gyro wheels (11) | Separating panel (12) |
| Upper deck (13) | Condensing pipes (131) |
| Lower deck (14) | Access door (15) |
| Doorknob (151) | Exhaust vent (16) |
| Power switch (17) | Cover (22) |

### DETAIL DESCRIPTION OF THE PREFERRED EMBODIMENT

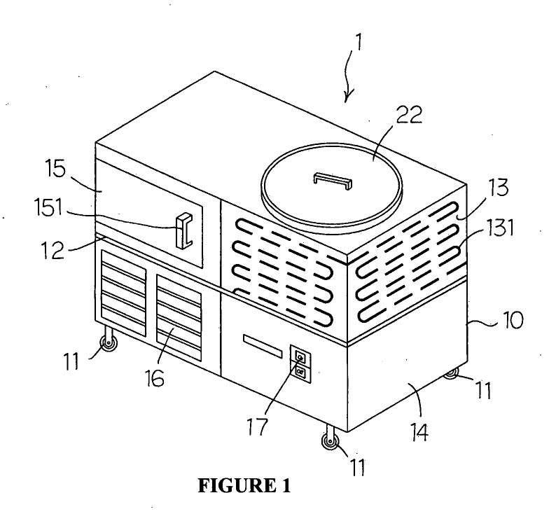

FIG. 1. Shows the basic structure of the cooling storage device in this invention. The cooling storage device has a shell (10), and there are gyro wheels at every corner on the bottom surface of it for the convenience of moving. Inside the shell (10), there is a separating panel (12) to separate the said shell into an upper and a lower deck (13, 14). The upper deck (13) can preserve and refrigerate food items. And there are condensing pipes (131) surrounding the inside walls of the upper space. Besides, an access door (15) with a doorknob (151) is setup to one side of upper deck for the convenience of putting in or taking out the food items. Inside the lower deck (14), there is at least one cooling system which can provide the function of refrigeration. And the cooling system is made up of a compressor, condenser, desiccator, and etc. The condensing pipe described above is also connected to the cooling system. Outside the lower deck (14) shell, there are an exhaust window and a switch on it.

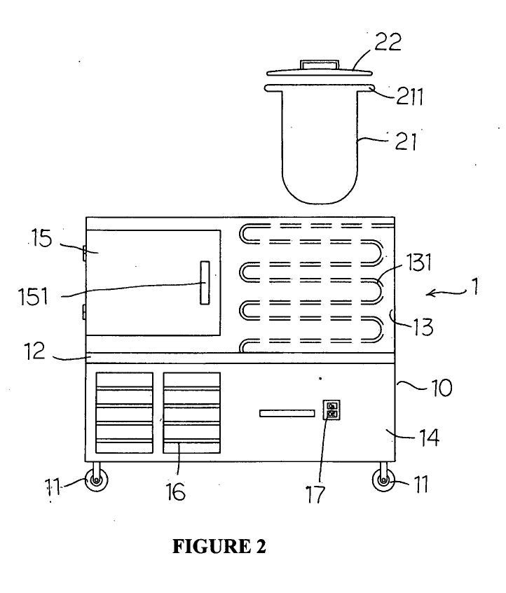

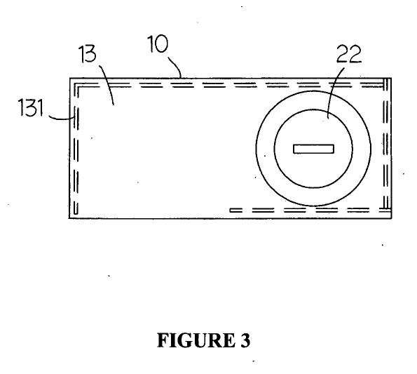

Please refer to the FIG. 2 and 3, the structure characteristics about this creation are: a punch (20) on the top surface of the shelf (10) which connects to the upper deck (13) inside the shell. This punch offers a space to place a container (21), and the salient of top edge of the container (21) is used to prevent the container (21) from falling down to the upper deck (13). On the top of the container, there is a cover (22) to enclose the container (21). In this way, the container (21) is hanged inside the upper deck. Thus, the container has the capabilities of preserving and refrigerating food material because it also under the influence of the condensing pipes. At the same time, we can open the cover (22) for putting in or taking out the stuff inside the container (21).

When using the cooling storage device described above, the user puts the food items inside the container (21) and place a cover (22) on it. At this time, the container (21) is hanged inside the upper deck (13); so the refrigeration function also exists inside the container (21) just like inside the upper deck (13), because they are under the influence of the condensing pipes directly or indirectly. When we want to take some food items, it is very convenient for user to open the cover (22) to take them out and bring them in when finish using it.

Because the user only use the container and the cover in the process of putting in and taking out the food items inside the container. Thus, the cold air inside the upper deck won't flow out, resulting in a saving of the energy. In sum, an easy way of putting in and taking out food items also with the advantage of saving energy is being achieved.

What is claimed is:

1. A kind of improvement in cooling storage device structure, the said cooling storage device structure mainly comprises: a shell, inside the said shell there is a separating panel which is used to separate the said shell into an upper and a lower deck; in the said upper deck, there are condensing pipes surrounding inside the walls; an access door with a doorknob setup at one side of the upper deck inside the above-mentioned lower deck, a cooling system is placed which provides the function of refrigeration; the said cooling system is generally made up of a compressor, a condenser, a desiccator, and etc.; the above-mentioned condensing pipes are also connected to the cooling system; outside the lower deck shell, there is an exhaust vent and a power switch; it characteristics lie in:
A punch on the top surface of the shell which connects to the upper deck inside the shell; the said punch offers a space to place a container, and the salient of top edge of the container is used to prevent the container from falling down to the upper deck through the said punch; a cover designed to enclose the foresaid container.

2. As mentioned in the claim 1, gyro wheels could be setup at every corner on the bottom surface of the shell.
